(19) United States
(12) Patent Application Publication
(10) Pub. No.: US 2011/0186378 A1
(43) Pub. Date: Aug. 4, 2011

(54) OPEN CHAMBER EXHAUST MUFFLERS AND RELATED METHODS OF MANUFACTURE AND USE

(75) Inventor: Dan Petschenig, Manotick (CA)

(73) Assignee: STEBRO PSD LTD., NEPEAN, ON (CA)

(21) Appl. No.: 13/120,309

(22) PCT Filed: Sep. 22, 2009
(86) PCT No.: PCT/CA09/01312

§ 371 Date: Apr. 12, 2011

Related U.S. Application Data
(60) Provisional application No. 61/098,937, filed on Sep. 22, 2008.

(51) Int. Cl. F01N 13/08; B23P 11/00

(52) U.S. Cl. 181/228; 29/428

(57) ABSTRACT

Open chamber exhaust mufflers and related methods of manufacture and use are disclosed. One embodiment of an exhaust muffler has a chamber body, absorbing material that at least dampens sound, and a retainer that retains the absorbing material against an inside surface of the chamber body and exposes an open interior chamber of the chamber body to the absorbing material. The chamber body has an inlet for receiving exhaust from an engine and an outlet for expelling exhaust gas from the exhaust muffler. The chamber body, the absorbing material, and the retainer define the open interior chamber, and the open interior chamber provides an exhaust gas flow area, for unrestricted flow of exhaust gas from the inlet to the outlet, which is larger than a gas flow area of at least one of the inlet and the outlet. An end cover of the chamber body is removable in some embodiments.

### CROSS-REFERENCE TO RELATED APPLICATION

This application claims the benefit of U.S. Provisional Patent Application Ser. No. 61/098,937, entitled “OPEN CHAMBER EXHAUST MUFFLERS AND RELATED METHODS OF MANUFACTURE AND USE”, and filed on Sep. 22, 2008, the entire contents of which are incorporated herein by reference.

### FIELD OF THE INVENTION

This invention relates generally to mufflers for combustion engines and, in particular, to exhaust mufflers for such engines.

### BACKGROUND

In one type of exhaust muffler, exhaust gas is directed through a series of flow tubes and baffles arranged in an interior muffler chamber. While these components cooperate to reduce sound levels, they also restrict the flow of exhaust gas through the muffler and can, for example, backpressure an engine to which such a muffler is attached. Each of the multiple components also represents a potential point of failure.

Substantially straight tube mufflers represent an alternate design in which exhaust gas passes through a single tube. Holes in the muffler tube may expose sound dampening material and/or other material(s), which are placed between the muffler tube and an outside casing of a muffler, to the interior of the tube. In these designs, resistance to exhaust gas flow in the muffler tube tends to be the roughly the same as or greater than resistance in exhaust tubes to which the muffler tube is connected, and the amount of exposure of the muffler material(s) tends to be limited in order to prevent the material(s) from blowing out of the muffler through the holes in the muffler tube. These mufflers tend not to meet acceptable sound level limits due to limited exposure of the muffler material(s). Increasing the extent of exposure of the muffler material(s) in order to reduce sound levels often leads to failure of the muffler material(s).

Conventional mufflers are also generally treated as consumption items, which are replaced entirely in the event of wear or failure.

### SUMMARY OF THE INVENTION

Thus, there remains a need for improved exhaust mufflers.

According to one aspect of the invention, there is provided an exhaust muffler comprising: a chamber body having an inlet for receiving exhaust from an engine and an outlet for expelling exhaust gas from the exhaust muffler; absorbing material that at least dampens sound; and a retainer that retains the absorbing material against an inside surface of the chamber body and exposes an open interior chamber of the chamber body to the absorbing material, the chamber body, the absorbing material and the retainer defining the open interior chamber, the open interior chamber providing an exhaust gas flow area, for unrestricted flow of exhaust gas from the inlet to the outlet, which is larger than a gas flow area of at least one of the inlet and the outlet.

In some embodiments, the open interior chamber provides an exhaust gas flow area which is both larger than the gas flow area of the inlet and larger than the gas flow area of the output.

In some embodiments, the chamber body comprises a first end cover comprising the inlet, a second end cover comprising the outlet, and a side wall extending between the first end cover and the second end cover, and the retainer retains the absorbing material against an inside surface of the side wall and against an inside surface of at least one of the first end wall and the second end wall.

In some embodiments, the retainer comprises a mesh.

In some embodiments, the mesh comprises a non-planar surface profile.

In some embodiments, the retainer retains the absorbing material in a compressed state against the inside surface of the chamber body.

In some embodiments, the chamber body comprises a first end cover comprising the inlet, a second end cover comprising the outlet, and a side wall extending between the first end cover and the second end cover, and at least one of the first end cover and the second end cover is releasably fastened to the side wall.

In some embodiments, the chamber body comprises a first end cover comprising the inlet, a second end cover comprising the outlet, and a side wall extending between the first end cover and the second end cover, and at least one of the first end cover and the second end cover has a frustoconical shape.

In some embodiments, the chamber body comprises a first body member and a second body member attached to the first body member.

A related method is also provided, and involves inserting, into a side wall for an exhaust muffler chamber body, absorbing material that at least dampens sound and a retainer for retaining the absorbing material against an inside surface of the side wall and exposing an open interior chamber of the exhaust muffler to the absorbing material; and installing a first end cover having an inlet for receiving exhaust from an engine and a second end cover having an outlet for expelling exhaust gas from the exhaust muffler. The first end cover, the second end cover, the absorbing material and the retainer define the open interior chamber, and the open interior chamber provides an exhaust gas flow area, for unrestricted flow of gas from the inlet to the outlet, which is larger than a gas flow area of at least one of the inlet and the outlet.

In some embodiments, the open interior chamber provides an exhaust gas flow area which is both larger than the gas flow area of the inlet and larger than the gas flow area of the output.

In some embodiments, the retainer further retains the absorbing material against an inside surface of at least one of the first end cover and the second end cover.

In some embodiments, the retainer comprises a mesh.

In some embodiments, the mesh comprises a non-planar surface profile.

In some embodiments, inserting comprises compressing the absorbing material between the retainer and the inside surface of the side wall.

In some embodiments, the method further comprises providing the side wall as an open side wall. Inserting may then comprise inserting the absorbing material and the retainer into the open side wall, and compressing may comprise closing the open side wall to compress the absorbing material.

In some embodiments, installing comprises releasably fastening at least one of the first end cover and the second end cover to the side wall.

In some embodiments, the method further comprises: removing the at least one of the first end cover and the second end cover; at least one of: cleaning and replacing the absorbing material; and fastening the at least one of the first end cover and the second end cover.

In some embodiments, at least one of the first end cover and the second end cover has a frustoconical shape.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is an isometric view of an exhaust muffler according to an embodiment of the invention.

FIG. 2 is a side view of the example exhaust muffler shown in FIG. 1.

FIGS. 3A and 3B are end views of the example exhaust muffler shown in FIG. 1.

FIG. 4 is a cross-sectional view of the example exhaust muffler along line 4-4 shown in FIG. 2.

FIG. 5 is a cross-sectional view of the example exhaust muffler along line 5-5 shown in FIG. 2.

FIG. 6 is a detail view of a portion of the example muffler shown in FIG. 4.

FIG. 7 is an isometric view of an exhaust muffler according to another embodiment of the invention.

FIG. 8 is a side view of an exhaust muffler according to a further embodiment of the invention.

FIG. 9 is a side view of an exhaust muffler according to yet another embodiment of the invention.

FIG. 10 is a side view of an exhaust muffler according to a still further embodiment of the invention.

FIG. 11 is an end view of the example exhaust muffler shown in FIG. 10, with the end cover 74 removed.

FIG. 12 is a flow diagram of a related method.

### DETAILED DESCRIPTION OF PREFERRED EMBODIMENTS

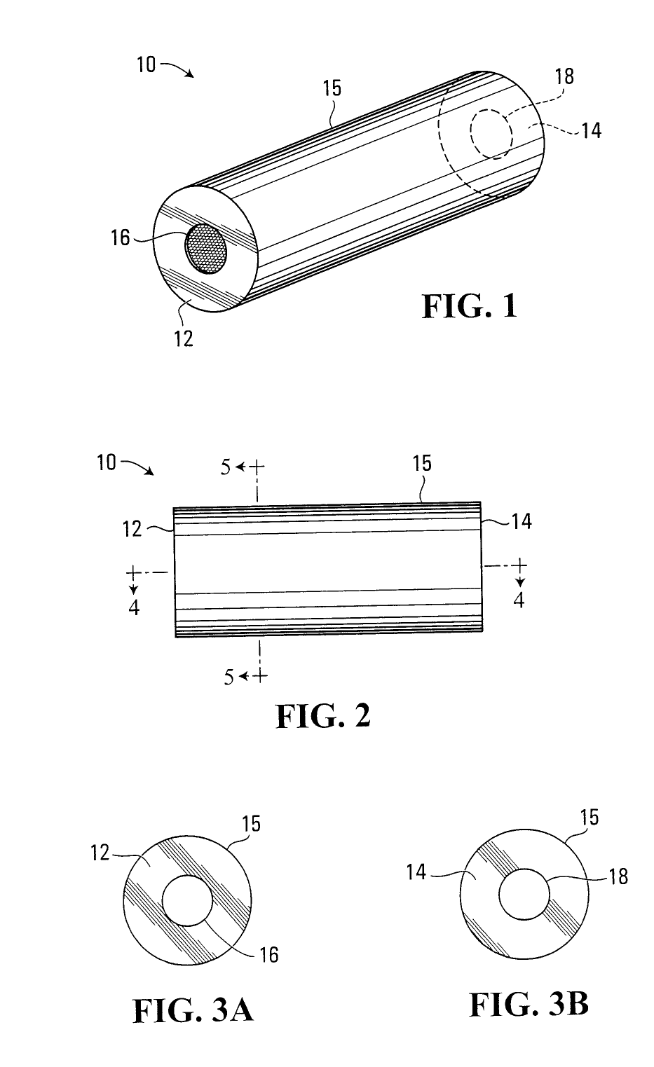

FIG. 1 is an isometric view of an exhaust muffler 10 according to an embodiment of the invention, and FIGS. 2, 3A, and 3B are side and end views thereof. Although the example exhaust muffler 10 is cylindrical in shape, other shapes are also contemplated. In general, it should be appreciated that the example muffler 10 of FIG. 1, as well as the contents of the other drawings, are intended solely for illustrative purposes, and that the present invention is in no way limited to the particular example embodiments explicitly shown in the drawings and described herein. For example, the size, shape, and makeup of an exhaust muffler may vary according to application and/or manufacturing constraints. Exhaust mufflers developed for different vehicles, for instance, may well have different sizes and shapes.

In general, size, length, and shape may be determined by the fitment application and the sound source of the application. The amount of sound reduction desired is proportional to the size of the exhaust muffler, since it is a sound absorption technology. A large exhaust muffler might be used to provide enough sound absorption area for a ‘loud’ acoustic source, for instance.

In the example shown, a chamber body is formed by a cylindrical side wall 15 and opposite end walls 12, 14. The end walls 12, 14 include an inlet 16 having an inlet for receiving exhaust from an engine and an outlet 18 for expelling exhaust gas from the exhaust muffler 10. In one embodiment, the chamber body is made from type 304 16-gauge stainless steel. Other materials may instead be used.

The chamber body could be constructed in any of various ways. For example, the cylindrical side wall 15 and the end walls 12, 14 might be separate components which are welded or otherwise fastened or attached together. The end walls 12, 14 could be provided as end covers, for example, and welded to the cylindrical side wall 15. Welding is one possible fastening technique. Chamber walls and/or other components could instead be crimped or bolted together, for instance.

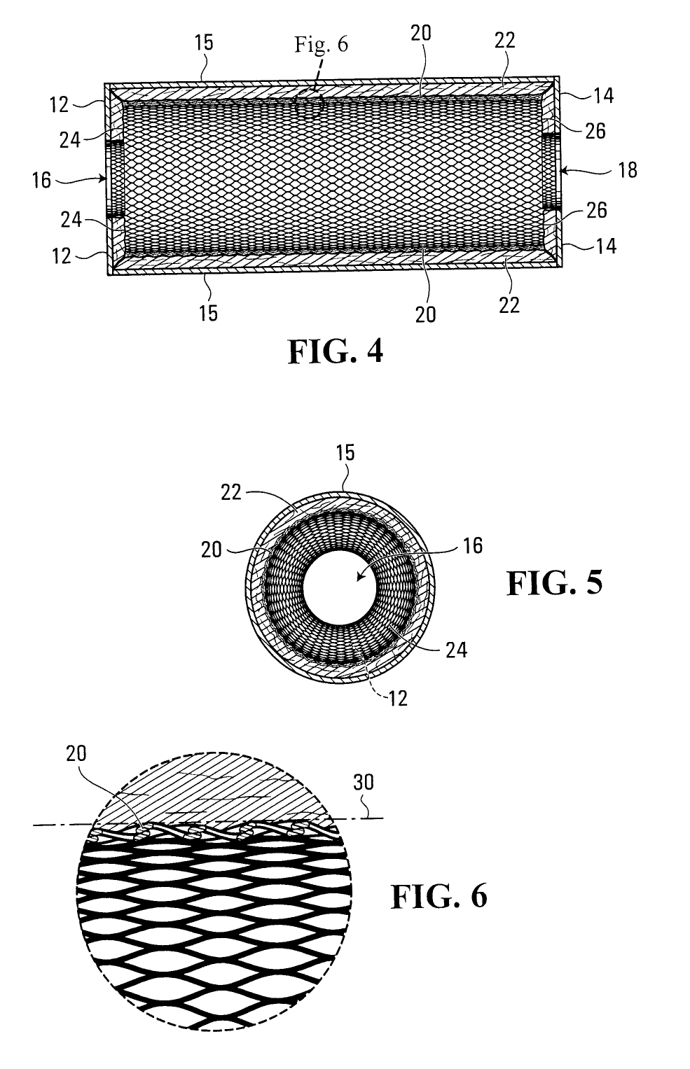

Embodiments of the invention can perhaps best be illustrated with reference to FIGS. 4 and 5, which are cross-sectional views of the example exhaust muffler 10 along lines 4-4 and 5-5 shown in FIG. 2. These drawings show an absorbing material 22, which at least dampens sound, and a retainer 20, which retains the absorbing material against an inside surface of the chamber body and exposes the open interior chamber of the chamber body to the absorbing material. In one embodiment, the absorbing material 22 is a fibrous material which is heat resistant, fire resistant, pressure wave resistant, and turbulent wave resistant. The absorbing material 22 not only dampens sound, but also traps pollutants such as particulates in exhaust gas in some embodiments. The retainer 20, like the chamber body, is made of a stainless steel in one embodiment, although other material(s) may instead be used.

FIGS. 4 and 5 clearly show that the chamber body, the absorbing material 22, and the retainer 20 define the open interior chamber, and that the open interior chamber provides a large exhaust gas flow area for unrestricted flow of exhaust gas from the inlet 16 to the outlet 18. The gas flow area provided by the open interior chamber is larger than a gas flow area of at least one of the inlet 16 and the outlet 18, and may be larger than the gas flow area of both, as in the example exhaust muffler 10.

In some embodiments, the retainer 20 includes additional portions 24, 26 for retaining the absorbing material 22 against an inside surface of either or both of the end walls 12, 14. References herein to a retainer are intended to encompass a single retainer which might have one or multiple portions for retaining absorbing material against different parts of the chamber body, as well as multiple-piece retainers for retaining absorbing material. The retainer 20 in the example muffler 10 includes a mesh basket, which extends around and along the inside of the cylindrical side wall 15 and terminates at the end walls 12, 14, and additional mesh portions 24, 26 for retaining the absorbing material 22 against the inside surfaces of the end walls 12, 14. The additional mesh portions 24, 26 may be provided as separate pieces or integrated with the mesh basket.

While the end portions 14, 16 might be welded or otherwise attached to the chamber body, the mesh basket could be sized for a friction fit against the cylindrical side wall and/or to be captured and held between the end walls 12, 14. Other arrangements are also possible.

The retainer 20 retains the absorbing material 22 in a compressed state against the inside surface of the chamber body in some embodiments. For example, the absorbing material is compressed to 50% of its normal thickness in one embodiment. The absorbing material may also be compressed in other dimensions as well. For example, the retainer 20 and the absorbing material 22 could both be compressed axially by end covers during manufacturing. Axial compression by 20% is achieved in one embodiment. Compression of the absorbing material 22 may be advantageous in preventing the absorbing material from blowing out during use of the example exhaust muffler 10.

In operation, exhaust gas which enters the inlet 16 is able to expand into the open interior chamber, which as noted above provides a large gas flow area. This reduces the pressure of the exhaust gas. The interior gas flow path is unobstructed by internal components, and thus the exhaust gas is not restricted in its flow from the inlet 16 to the outlet 18. At the outlet 18, which in the example shown is smaller than the open interior chamber, the exhaust gas is compressed and speeds up, and is expelled from the outlet 18. This compression and increase in speed effectively pull exhaust gas toward the outlet 18, further increasing exhaust gas flow.

In the example exhaust muffler 10, the flow area provided by the open interior chamber is larger than that of both the inlet 16 and the outlet 18. However, in some embodiments, a cross-sectional area of the open interior chamber or the chamber body could be substantially the same as the cross-sectional area of either the inlet or the outlet. While this is one possible configuration, providing a flow area in the open interior chamber that is larger than that of both the inlet 16 and the outlet 18, as shown, derives all of the benefits noted in the preceding paragraph.

Apart from the inlet 16, where turbulent gas flow at entry into the interior chamber might create flow resistance, exhaust gas experiences relatively little resistance in flowing from the inlet to the outlet 18. Although the exhaust gas is compressed at the output 18, it also speeds up, which counteracts flow resistance that might otherwise result from the compression.

Air flow resistance can be further decreased within the open interior chamber. For example, the mesh forming the retainer 20 may have a non-planar surface profile, as shown in FIG. 6 relative to a reference line 30. Such a profile creates exhaust gas turbulence or eddy currents along the surface of the mesh. This results in a flow of gas against gas in the open interior chamber, which in turn results in lower flow resistance. A retainer 20 in the form of a mesh provides for effective exposure of the absorbing material 22 to the open interior chamber, while retaining the absorbing material against blow-out. In one embodiment, the openings in the mesh are ¼″ by 5/16″. Compression of the absorbing material 22 also aids in preventing blow-out.

With improved air flow, there is less backpressure to an engine, which can improve engine fuel efficiency and performance. Improved air flow can also improve heat transfer from an engine through its exhaust system, further improving performance.

The absorbing material 22 at least dampens sound, as noted above. Sound waves are absorbed, instead of reflected, by the absorbing material, which reduces the level of sound remaining at the outlet 18. A mesh or other substantially open retainer structure improves sound dampening by increasing the amount of the absorbing material that is exposed to the open interior chamber. In muffler designs with perforated tubes, for example, exposure tends to be much less than with a mesh. A mesh retainer such as shown in FIG. 6, which is not flattened as will be apparent from the line 30, has raised edges to capture more sound.

The large size of the open chamber itself further increases the amount of the absorbing material 22 that is exposed to sound waves in an exhaust system. Dimensions of the example exhaust muffler 10 can also be varied to capture longer wavelength sound waves, thereby further improving sound dampening. In one embodiment, an exhaust muffler of the type shown in FIGS. 1 to 6 is 48″ long and has an 11″ diameter, although other sized are also of course contemplated. In general, exhaust muffler volume, width, and length may be determined in accordance with a particular application and engine sound characteristics.

Whereas sound waves are at least dampened by the increased exposure of absorbing material 22, the open interior chamber does not obstruct pressure waves and thus allows pressure waves to pass through. Pressure and sound waves are thereby effectively separated.

The specific example exhaust muffler 10 shown in FIGS. 1 to 6 and described above is intended solely for the purposes of illustration. Other embodiments may include additional or different features.

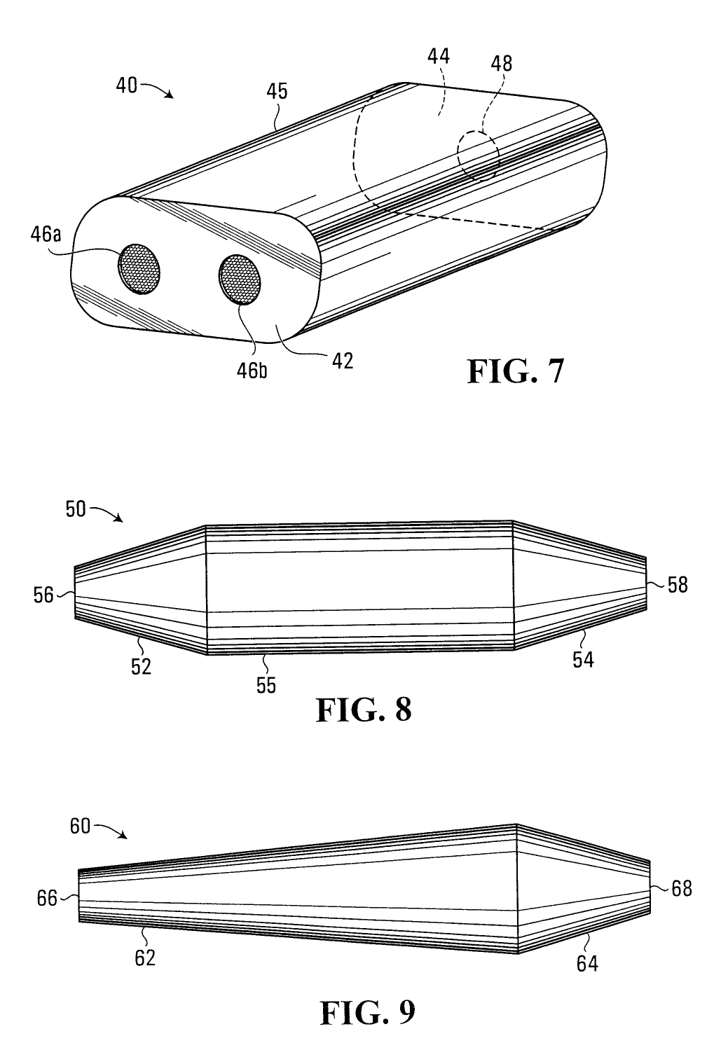

FIG. 7, for example, which is an isometric view of an exhaust muffler 40 according to another embodiment of the invention, illustrates two possible variations. In the example exhaust muffler 40, the chamber body has a substantially rectangular shape, formed by a side wall 45 and end walls 42, 44. Another variation shown in FIG. 7 is that multiple inlets and/or outlets may be provided. The example exhaust muffler 40 may have two inlets 46a, 46b and one outlet 48, or one inlet 48 and two outlets 46a, 46b. Other shapes and/or configurations of inlets and outlets are also possible. The inlet and/or outlet could be in the side(s) of an exhaust muffler instead of the ends, for instance.

FIG. 8 is a side view of an exhaust muffler 50 according to a further embodiment of the invention. In the example exhaust muffler 50, the chamber body includes a first end cover 52 with an inlet 56, a second end cover 54 with an outlet 58, and a cylindrical side wall 55 extending between the end covers. Both of the end covers have a frustoconical shape in the example shown.

The shape of the end covers 52, 54 effectively eases the transitions between the inlet 56 into an open interior chamber of the example exhaust muffler 50 and between the open interior chamber and the outlet 56. The inlet end cover 52 reduces turbulent flow at the inlet 56, and the outlet end cover 54 provides for easier compression of exhaust air for expulsion through the outlet 58. Although both ends of the chamber body have frustoconical end covers 52, 54 in FIG. 8, other embodiments may include such end covers at only one end, for example.

References herein to a chamber body are intended to encompass any of many different forms in which a chamber body might be provided. For example, the exhaust muffler 60 shown in FIG. 9 is illustrative of an embodiment in which a chamber body includes two body members 62, 64 attached to each other. The body members have openings 66, 68 to be used as an inlet and an outlet. This type of configuration could be considered a form of chamber body that is constructed from two end covers, without a side wall extending between them.

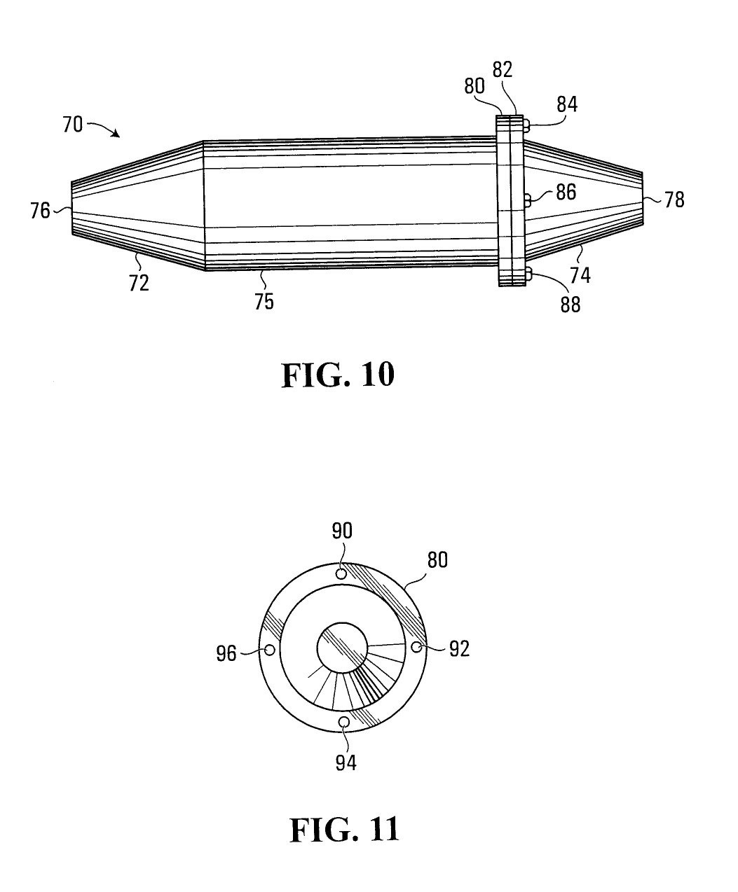

According to another aspect of the invention, one or both end covers of a chamber body are removable. FIG. 10 is a side view of an exhaust muffler 70 which is illustrative of such an embodiment of the invention, and FIG. 11 is an end view of the example exhaust muffler in FIG. 10, with the end cover 74 removed. In the example exhaust muffler 70, the chamber body includes an end cover 72 having an inlet 76, an end cover 74 having an outlet 78, and a cylindrical side wall 75 extending between the end covers. The end cover 74 is releasably fastened to the side wall 75, by a flange arrangement in the example shown.

A flange 80 is attached to the cylindrical side wall 75, illustratively by welding, and a flange 82 is fastened to the flange 80 using bolts 84, 86, 88. The flange 84 is also attached to the end cover 74 by welding in one embodiment, and thereby releasably fastens the end cover to the cylindrical side wall 75. Other components such as a seal or gasket may also be partially or entirely captured between the flanges 80, 82 in order to provide a fluid-tight seal.

As will be apparent from FIG. 11, the flange 80 in this example has four bores 90, 92, 94, 96 for receiving the bolts 84, 86, 88, and an additional bolt which is not visible in FIG. 10. These bores may be threaded, so that removal of the end cover 74 does not require the removal of both the bolts 84, 86, 88 and corresponding nuts, although the exact manner of releasable fastening of an end cover may vary between different applications or embodiments.

The open interior chamber of the example exhaust muffler 70 is accessible by removing the bolts 84, 86, 88, and, in the example shown in FIG. 11, an additional bolt. The end cover 74 and the flange 82 can then be removed.

Post-installation access to the open interior chamber of the example exhaust muffler 70 may provide several advantages. An absorbing material which is provided in the open interior chamber may provide other functions as well. In some embodiments, the absorbing material also captures particulates in exhaust gas. However, the particulate capturing capability of such a material will be limited. Once the material has reached its capacity to capture particulates, the particulates in exhaust gas will substantially pass through the exhaust muffler. Such particulate saturation might also impact sound damping performance. Traditionally, a muffler would either be kept in service despite its degraded performance or replaced entirely.

Access to the open interior space of the example exhaust muffler 70 provides the options of cleaning and replacing the absorbing material, and possibly other components. The absorbing material could be cleaned, for example, by vacuuming. A retainer could similarly be accessed for repair and/or replacement. With a removable end cover at both ends, the entire side wall 75 and its absorbing material and retainer could be replaced.

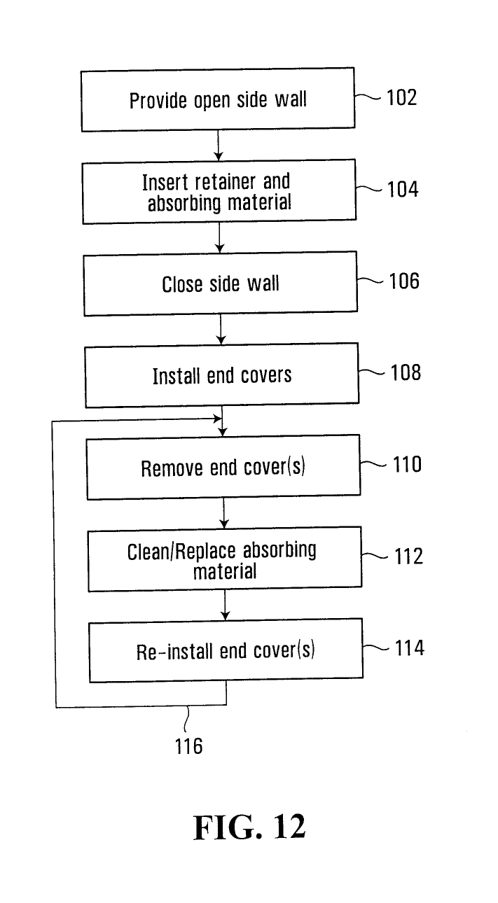

The foregoing description relates primarily to exhaust mufflers. FIG. 12 is a flow diagram of a related method.

The method involves providing a side wall at 102. This might entail pinch rolling sheet steel into a roughly cylindrical shape, for example. In one embodiment described in further detail below, the side wall may be open during assembly of an exhaust muffler.

At 104, absorbing material that at least dampens sound and a retainer for retaining the absorbing material against an inside surface of the side wall and exposing an open interior chamber of the exhaust muffler to the absorbing material are inserted into the side wall. This might involve compressing the absorbing material between the retainer and the inside surface of the side wall. For an open side wall, the inserting operation could entail inserting the absorbing material and the retainer into the open side wall, and closing the open side wall to compress the absorbing material. The side wall would then be closed, illustratively by welding, at 106. In the case of a cylindrical side wall, for instance, the side wall might be open along its length, and then closed and welded to compress the absorbing material and hold the absorbing material and the retainer inside.

In some embodiments, a chamber body includes a side wall and opposite end walls, in the form of end covers. At 108, these end covers are installed. At this point, the end covers, the absorbing material, and the retainer define the open interior chamber. As described above, the open interior chamber provides an exhaust gas flow area, for unrestricted flow of gas from the inlet to the outlet, which is larger than a gas flow area of at least one of an inlet and an outlet.

One or both end covers may be releasably fastened to the side wall at 108. In this case, at least one of the end cover covers could be removed at 110, in order to clean and/or replace the absorbing material as shown at 112. The retainer and/or the entire side wall assembly including the absorbing material and the retainer could similarly be replaced, repaired, or cleaned. The removed end cover(s) would then be re-installed at 114. As shown at 116, the operations at 110, 112, 114 might be repeated, at regular time and/or driving distance intervals, for instance.

What has been described is merely illustrative of the application of principles of embodiments of the invention. Other arrangements and methods can be implemented by those skilled in the art without departing from the scope of the present invention.

We claim:

1. An exhaust muffler comprising:
a chamber body having an inlet for receiving exhaust from an engine and an outlet for expelling exhaust gas from the exhaust muffler;
absorbing material that at least dampens sound; and
a retainer that retains the absorbing material against an inside surface of the chamber body and exposes an open interior chamber of the chamber body to the absorbing material,
the chamber body, the absorbing material and the retainer defining the open interior chamber, the open interior chamber providing an exhaust gas flow area, for unrestricted flow of exhaust gas from the inlet to the outlet, which is larger than a gas flow area of at least one of the inlet and the outlet.

2. The exhaust muffler of claim 1, wherein the open interior chamber provides an exhaust gas flow area which is both larger than the gas flow area of the inlet and larger than the gas flow area of the output.

3. The exhaust muffler of claim 1, wherein the chamber body comprises a first end cover comprising the inlet, a second end cover comprising the outlet, and a side wall extending between the first end cover and the second end cover, and wherein the retainer retains the absorbing material against an inside surface of the side wall and against an inside surface of at least one of the first end wall and the second end wall.

4. The exhaust muffler of claim 1, wherein the retainer comprises a mesh.

5. The exhaust muffler of claim 4, wherein the mesh comprises a non-planar surface profile.

6. The exhaust muffler of claim 1, wherein the retainer retains the absorbing material in a compressed state against the inside surface of the chamber body.

7. The exhaust muffler of claim 1, wherein the chamber body comprises a first end cover comprising the inlet, a second end cover comprising the outlet, and a side wall extending between the first end cover and the second end cover, and wherein at least one of the first end cover and the second end cover is releasably fastened to the side wall.

8. The exhaust muffler of claim 1, wherein the chamber body comprises a first end cover comprising the inlet, a second end cover comprising the outlet, and a side wall extending between the first end cover and the second end cover, and wherein at least one of the first end cover and the second end cover has a frustoconical shape.

9. The exhaust muffler of claim 1, wherein the chamber body comprises a first body member and a second body member attached to the first body member.

10. A method comprising:
inserting, into a side wall for an exhaust muffler chamber body, absorbing material that at least dampens sound and a retainer for retaining the absorbing material against an inside surface of the side wall and exposing an open interior chamber of the exhaust muffler to the absorbing material;
installing a first end cover having an inlet for receiving exhaust from an engine and a second end cover having an outlet for expelling exhaust gas from the exhaust muffler,
the first end cover, the second end cover, the absorbing material and the retainer defining the open interior chamber, the open interior chamber providing an exhaust gas flow area, for unrestricted flow of gas from the inlet to the outlet, which is larger than a gas flow area of at least one of the inlet and the outlet.

11. The method of claim 10, wherein the open interior chamber provides an exhaust gas flow area which is both larger than the gas flow area of the inlet and larger than the gas flow area of the output.

12. The method of claim 10, wherein the retainer further retains the absorbing material against an inside surface of at least one of the first end cover and the second end cover.

13. The method of claim 10, wherein the retainer comprises a mesh.

14. The method of claim 13, wherein the mesh comprises a non-planar surface profile.

15. The method of claim 10, wherein inserting comprises compressing the absorbing material between the retainer and the inside surface of the side wall.

16. The method of claim 15, further comprising:
providing the side wall as an open side wall,
wherein inserting comprises inserting the absorbing material and the retainer into the open side wall,
wherein compressing comprises closing the open side wall to compress the absorbing material.

17. The method of claim 10, wherein installing comprises releasably fastening at least one of the first end cover and the second end cover to the side wall.

18. The method of claim 17, further comprising:
removing the at least one of the first end cover and the second end cover;
at least one of: cleaning and replacing the absorbing material; and
fastening the at least one of the first end cover and the second end cover.

19. The method of claim 10, wherein at least one of the first end cover and the second end cover has a frustoconical shape.
